(19) United States
(12) Patent Application Publication
(10) Pub. No.: US 2002/0005194 A1
(43) Pub. Date: Jan. 17, 2002

(54) COOKING GRILL WITH ANTIMICROBIAL AGENT

(76) Inventors: JEFFREY A. TROGOLO, BOSTON, MA (US); JOHN E. BARRY, DERRY, NH (US)

Correspondence Address: EDWARD K. WELCH II, AGION TECHNOLOGIES, L.L.C., 60 AUDUBON ROAD, WAKEFIELD, MA, 01880, US

(21) Appl. No.: 09/260,580

(22) Filed: Mar. 1, 1999

(51) Int. Cl. F24B 3/00; A47J 37/00; F24C 3/00

(52) U.S. Cl. 126/25 R; 126/41 R

(57) ABSTRACT

A cooking grill having surfaces such as a hood, side table, a hood handle and control knobs which are to be contacted by the hands of the grill user, food, food juices and utensils provide sites for bacteria growth and cross-contamination to the food. Such surfaces contain an antimicrobial agent either incorporated in the material forming a component having the surface or a coating such as a paint or powder applied to a surface.

### FIELD OF THE INVENTION

The invention relates to cooking grills having various components containing an antimicrobial agent.

### BACKGROUND OF THE INVENTION

Cooking with a grill, such as a gas or charcoal grill, presents several problems with respect to maintaining cleanliness and thereby avoiding problems, such as food poisoning caused by bacteria. While food poisoning due to bacteria can be the result of under cooked food it also can result from cross-contamination between the food and cooking implements used with the grill as well as between the food and the person handling it.

For example, one mechanism of cross-contamination includes hand contact with components of the grill, such as the cover handle, control knobs, utensils, etc., and then contact with the food. Another mechanism is spillage of the juices from raw meat on a side table found with many grills followed by placement of other prepared foods, utensils or hand contact with that surface thereby resulting in cross-contamination. In each mechanism on the grill components and side table any residue of food provides a site for growth of bacteria.

Steps can be taken to avoid such cross-contamination. Such steps include, for example, providing extra plates for holding the meat, washing the hands between various stages of the handling and cooking process, etc. All of these involve extra effort on the part of the person doing the cooking. Unfortunately, it is not always possible to insure that the steps are followed at all times.

Therefore, it would be desirable to provide systems and implements which are self-acting and avoid the need for human intervention to reduce the potential problems of cross-contamination.

### BRIEF DESCRIPTION OF THE INVENTION

The present invention relates to a cooking grill that has various surfaces formed of or treated with an inorganic antimicrobial agent. Such agents kill many of the types of bacteria found in food. Thus, such surfaces will be relatively bacteria free when contacted by the person doing the cooking, thus reducing the possibility of cross-contamination.

### OBJECTS OF THE INVENTION

It is therefore an object of the present invention to provide a cooking grill having various surfaces which include an antimicrobial agent.

A further object is to provide a cooking grill having those of its surfaces with which the hands of the person doing the cooking and/or surfaces with which the food come into contact either formed by or coated with a material containing an antimicrobial agent, preferably a zeolite.

Yet another object is to provide a cooking grill having certain of its surfaces coated with hand inorganic antimicrobial agent or certain of its components formed of a material which include an inorganic antimicrobial agent.

### BRIEF DESCRIPTION OF THE DRAWINGS

Other objects and advantages of the present invention will become more apparent upon reference to the following specification and annexed drawings in which:

FIG. 1 is a perspective view of a typical cooking grill; and

FIG. 2 is an elevational view, partly in cross-section, of a part of the grill.

### DETAILED DESCRIPTION OF THE INVENTION

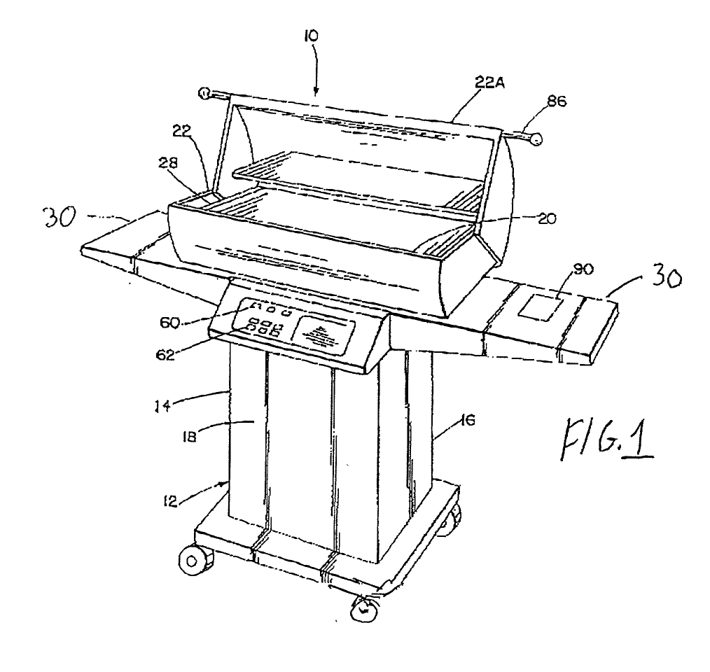

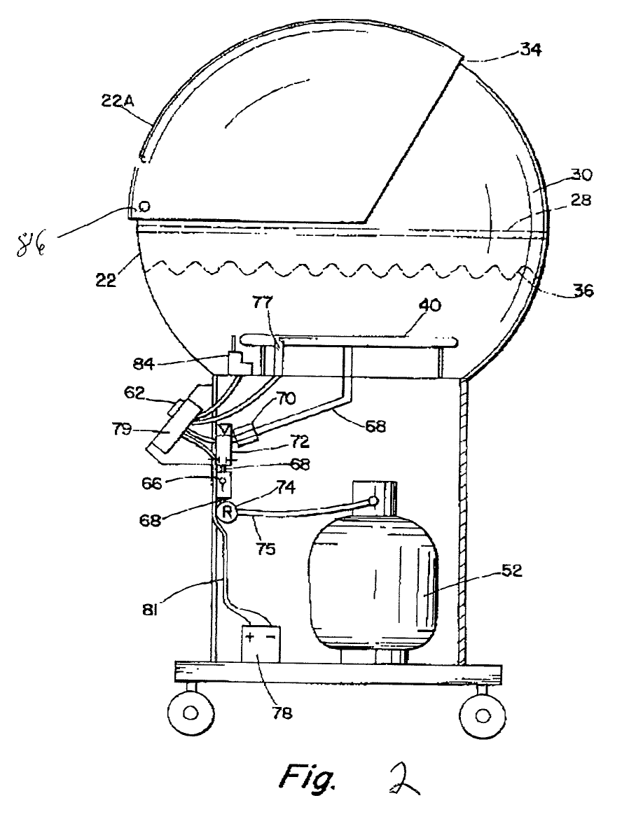

FIGS. 1 and 2 show a typical outdoor gas type cooking grill with which the principles of the present invention can be embodied. It should be understood that these principles can be applied to any type and size of such grill.

The grill is generally designated 10 and has a base housing 12 with laterally spaced side walls 14, 16 and a front wall 18 connected to the side walls.

The base 12 is equipped with casters or other types of rollers. Typically, the side walls 14, 16 and the front wall 18 are formed from one sheet and are of metal such as steel, although separate pieces can be used for the walls. A table 30 extends from the top of each side of the base 12.

A generally cylindrical cooking cavity 22 is on the top of base 12. The cooking cavity 22 includes a pivoting top lid 22 A connected by hinges to the side walls of the cooking cavity. There is a handle 86 at each end of the hood 22 A.

Extending horizontally within the cooking cavity 22 at the level of the upper range of the front wall 20 is a food-receiving rack 28. Alternatively, the rack 28 may be fastened to the housing 12 so as to be vertically adjustable thereon. Whatever the mounting arrangement, the rack 28 is to be securely mounted so that it serves as a barrier which protects the lower components of the grill. Air flow through the cooking chamber 20 is provided by a vent 34 in the top of the cooking cavity.

The cooking chamber 22 is also preferably provided with a horizontally disposed grate 36 mounted below the food receiving rack 28. The grate can be welded at its edges to adjoining portions of the front, side and rear walls, or it may be fastened to the cooking chamber 22 so as to be vertically adjustable. The grate 36 is heated directly by a burner 40 below the grate which also radiates heat over a relatively large portion of the food-receiving rack 28.

Below the cooking chamber 20 at the top end of the housing 16 is a table 70 on each side of the chamber which provides a surface for holding the food, plates, and other implements.

Within the housing 12 there is shown a gas supply pipe 68 to the burner 40 connected to a solenoid-actuated valve 72 by a conduit 75 from a gas supply cylinder 52. A manual valve 66 may be mounted in the gas supply pipe 68. A conventional flow regulator 74 is provided between the gas supply cylinder 52 and the solenoid-actuated valve 72, the latter being electrically connected to a control circuit or panel 79 which houses various elements for controlling the (timing of the cooking steps. The electrical components of the system are powered by a battery 78, which is connected to the control panel 79 by way of conductor 81. The control panel 79 has a control having one or more central knobs and buttons 60 and 62 for the gas supply to the burner 40, one of which is to a burner igniter 84 and a gas control feed 77. The battery 78 may be assisted or replaced by solar cell 90.

It should be understood that the type of grill shown and described above is only for purposes of illustration. It clearly illustrates that there are a number of surfaces which can be contacted by the hand of the user, such as the cover 22 A, the cover handles 86, and the control knobs 60 and 62, and also for the food and hands to contact, such as the tables 40. All of these surfaces provide sites for bacteria to reside and grow. Thus, they are available to be contacted by the hand of the user thus providing a potential transfer location to the food.

Paint

The paint on various components of grills can be applied as a liquid spray or as a powder coating. If a liquid paint is used, the inorganic antimicrobial can be incorporated into the paint by first dispersing the antimicrobial agent in a solvent or in the paint to make a concentrate consisting of 1 to 60% inorganic antimicrobial agent, preferably 5 to 50%, most preferably 10 to 40%. The concentrate is then added to the paint in an amount to result in the inorganic antimicrobial comprising 0.1 to 30% of the coating solids, preferably 0.5 to 15%, most preferably 1 to 10%.

Powder Coating

If a powder coating is used, the inorganic antimicrobial can be incorporated into the powder, blended directly with the powder or applied in a second step to the surface of a powder coated part before the baking step. Incorporation of the inorganic antimicrobial into the powder can be accomplished by preparing a master batch concentrate (same ranges as the concentrate above) which is then blended into the same or a different polymer to the desired concentration of between 0.1 to 30%, preferably 0.5 to 15%, most preferably 1 to 10%. This material is ground or melt atomized to produce a powder that is used directly or diluted with untreated powder in the conventional powder coating process.

An alternate method is to combine untreated polymer powder with a solution of an appropriate solvent, with or without a binder, and an inorganic antimicrobial to achieve a coating of the inorganic antimicrobial on the polymer powder particles. The solvent is then evaporated and the powder is used in the conventional powder coating process ensuring that the inorganic antimicrobial is exposed at the surface. Another method of producing an antimicrobial powder coating is to apply the powder in the conventional means and then apply a coating of the inorganic antimicrobial in a solvent or water. The part is then dried and based as in the conventional powder coating process, thus incorporating the inorganic antimicrobial specifically into the near surface of the coating.

If the grill has an accessory cage, not shown in the drawings, this can be powder coated using one of the methods described above.

The side tables can be manufactured from a metal substrate which is powder coated as described above. Alternate materials are wood and fiberglass.

Treated Wood

Wood can be treated with wood stain or by coating or submersing in a resin based solution containing an inorganic antimicrobial. The resin systems that can be used include polyurethane, acrylic, latex or another wood treatment.

Polymer Components

The grill has a number of components of plastic material. The side tables can be of reinforced polymers such as PET or unfilled polymers such as ABS, polypropylene, nylon, phenolic resin or other polymers, particularly those with high temperature stability to avoid damage by hot utensils. These resins are prepared as described above, by first preparing a master batch concentrate. Where zeolites are used as the agent, they are often obtained in master batches of low density polyethylene, polypropylene, or polystyrene, containing 20 wt % of the zeolite. Thus, they can be easily mixed with the resins used as thermoplastic materials for forming the composite resin used to make the polymer components according to the invention. The master batch concentration is added, and may be kneaded into untreated resin to result in a final concentration of between 0.1 to 30%, preferably 0.5 to 15%, most preferably 1 to 10% of the agent. Final formation of the tables can be by compression molding, extrusion or other conventional forming methods.

Knobs and handles are preferably injection molded from polymers, such as ABS, nylon, phenolic, polystyrene or other polymers. The inorganic antimicrobial is incorporated into the polymers using the master batch concentrate method described above. Methods for incorporating the antimicrobial agent in the resin are described in U.S. Pat. Nos. 4,938,955 and 4,906,464. The resins are then molded to form the components.

While specific amounts of the antimicrobial agent are given, it should be considered that in each case that there is an amount of the agent that is sufficient to produce an effective concentration. This means that there is a sufficient amount of the antimicrobial agent used alone, added to or combined with other materials such as to prevent or inhibit the growth of bacterial and/or fungal organisms or to kill such organisms. The amount of the agent will vary based on the specific agent used and the material with which it is mixed or added to and upon known factors such as pharmaceutical characteristics and the type and size of the component, implement, coating or surface. Environmental factors such as temperature and humidity also should be taken into consideration. It is within the ability of one skilled in the art to relatively easily determine an effective amount of the antimicrobial agent to be used with each material in light of the present disclosure.

As to the inorganic antimicrobial agent incorporated in the resin for the grill plastic components or used in the coating powder and paint, a number of metal ions, which are inorganic materials, have been shown to possess antimicrobial activity, including silver, copper, zinc, mercury, tin, lead, bismuth, cadmium, chromium and thallium ions. These antimicrobial metal ions are believed to exert their effects by disrupting respiration and electron transport systems upon absorption into bacterial or fungal cells. Antimicrobial metal ions of silver, gold, copper and zinc, in particular, are considered safe even for in vivo use. Antimicrobial silver ions are particularly useful for in vivo use due to the fact that they are not substantially absorbed into the body. That is, if such materials are used they should pose no hazard.

In one embodiment of the invention, the inorganic antimicrobial metal containing composition is an antimicrobial metal salt. Such salts include silver acetate, silver benzoate, silver carbonate, silver ionate, silver iodide, silver lactate, silver laureate, silver nitrate, silver oxide, silver palpitate, silver protein, and silver sulfadiazine. Silver nitrate is preferred. These salts are particularly quick acting, as no release from ceramic particles is necessary to function antimicrobially.

Antimicrobial zeolites have been prepared by replacing all or part of the ion-exchangeable ions in zeolite with ammonium ions and antimicrobial metal ions, as described in U.S. Pat. Nos. 4,938,958 and 4,911,898. Such zeolites have been incorporated in antimicrobial resins (as shown in U.S. Pat. Nos. 4,938,955 and 4,906,464) and polymer articles (U.S. Pat. No. 4,775,585). Polymers including the antimicrobial zeolites have been used to make refrigerators, dish washers, rice cookers, plastic film, chopping boards, vacuum bottles, plastic pails, and garbage containers. Other materials in which antimicrobial zeolites have been incorporated include flooring, wall paper, cloth, paint, napkins, plastic automobile parts, catheters, bicycles, pens, toys, sand, and concrete. Examples of such uses are described in U.S. Pat. Nos. 5,714,445; 5,697,203; 5,562,872; 5,180,585; 5,714,430; and 5,102,401. These applications involve slow release of antimicrobial silver from the zeolite particles which is suitable for components of the grill.

The ceramics used in the antimicrobial ceramic particles of the present invention include zeolites, hydroxy apatite, zirconium phosphates or other ion-exchange ceramics. Zeolites are preferred, and are described in the preferred embodiments referred to below. Hydroxy apatite particles containing antimicrobial metals are described, e.g., in U.S. Pat. No. 5,009,898. Zirconium phosphates containing antimicrobial metals are described, e.g., in U.S. Pat. Nos. 5,296,238; 5,441,717; and 5,405,644.

Antimicrobial zeolites are well-known and can be prepared for use in the present invention using known methods. These include the antimicrobial zeolites disclosed, for example, in U.S. Pat. Nos. 4,938,958 and 4,911,898.

Either natural zeolites or synthetic zeolites can be used to make the antimicrobial zeolites used in the present invention. “Zeolite” is an aluminosilicate having a three dimensional skeletal structure that is represented by the formula: XM₂/nO—Al₂O₃—YSiO₂—ZH₂O. M represents an ion-exchangeable ion, generally a monovalent or divalent metal ion, n represents the atomic valency of the (metal) ion, X and Y represent coefficients of metal oxide and silica respectively, and Z represents the number of water of crystallization. Examples of such zeolites include A-type zeolites, X-type zeolites, Y-type zeolites, T-type zeolites, high-silica zeolites, sodalite, mordenite, analcite, clinoptilolite, chabazite and erionite. The present invention is not restricted to use of these specific zeolites.

The ion-exchange capacities of these zeolites are as follows: A-type zeolite=7 meq/g; X-type zeolite=6.4 meq/g; Y-type zeolite=5 meq/g; T-type zeolite=3.4 meq/g; sodalite=11.5 meq/g; mordenite=2.6 meq/g; analcite=5 meq/g; clinoptilolite=2.6 meq/g; chabazite=5 meq/g; and erionite=3.8 meq/g. These ion-exchange capacities are sufficient for the zeolites to undergo ion-exchange with ammonium and antimicrobial metal ions.

The specific surface area of preferred zeolite particles is preferably at least 150 m²/g (anhydrous zeolite as standard) and the SiO₂/Al₂O₃ mol ratio in the zeolite composition is preferably less than 14, more preferably less than 11.

The antimicrobial metal ions used in the antimicrobial zeolites should be retained on the zeolite particles through an ion-exchange reaction. Antimicrobial metal ions which are adsorbed or attached without an ion-exchange reaction exhibit a decreased bacteriocidal effect and their antimicrobial effect is not long-lasting. Nevertheless, it is advantageous for imparting quick antimicrobial action to maintain a sufficient amount of surface adsorbed metal ion.

In the ion-exchange process, the antimicrobial metal ions tend to be converted into their oxides, hydroxides, basic salts etc. either in the micropores or on the surfaces of the zeolite and also tend to deposit there, particularly when the concentration of metal ions in the vicinity of the zeolite surface is high. Such deposition tends to adversely affect the bacteriocidal properties of ion-exchanged zeolite.

In an embodiment of the antimicrobial zeolites, a relatively low degree of ion exchange is employed to obtain superior bacteriocidal properties. It is believed to be required that at least a portion of the zeolite particles retain metal ions having bacteriocidal properties at ion-exchangeable sites of the zeolite in an amount less than the ion-exchange saturation capacity of the zeolite. In one embodiment, the zeolite employed in the present invention retains antimicrobial metal ions in an amount up to 41% of the theoretical ion-exchange capacity of the zeolite. Such ion-exchanged zeolite with a relatively low degree of ion-exchange may be prepared by performing ion-exchange using a metal ion solution having a low concentration as compared with solutions conventionally used for ion exchange.

In antimicrobial zeolite particles used in the present invention, ion-exchangeable ions present in zeolite, such as sodium ions, calcium ions, potassium ions and iron ions, are preferably partially replaced with ammonium and antimicrobial metal ions. Such ions may co-exist in the antimicrobial zeolite particle since they do not prevent the bacteriocidal effect. Antimicrobial metal ions include ions of silver, copper, zinc, mercury, tin, lead, bismuth, cadmium, chromium and thallium.

The antimicrobial metal ion is preferably present in the range of from about 0.1 to 20 wt. % of the zeolite. In one embodiment, the zeolite contain from 0.1 to 20 wt. % of silver ions and from 0.1 to 20 wt. % of copper or zinc ions. Although ammonium ion can be contained in the zeolite at a concentration of about 20 wt. % or less of the zeolite, it is desirable to limit the content of ammonium ions to from 0.5 to 15 wt. %, preferably 1.5 to 5 wt. %. Weight % described herein is determined for materials dried at temperatures such as 110° C., 250° C. or 550° C. as this is the temperature employed for the preferred post-manufacturing drying process.

A preferred antimicrobial zeolite is type A zeolite containing either a combination of ion-exchanged silver, zinc, and ammonium or silver and ammonium. One such zeolite is manufactured by Shinagawa, Inc. (a/k/a Shinanen) under the product number AW-10N and consists of 0.6% by weight of silver ion-exchanged in Type A zeolite particles having an average particle size of about 2.5μ. Another formulation, AJ-10N, consists of about 2% by weight silver ion-exchanged in Type A zeolite particles having an average particle size of about 2.5μ. Another formulation, AW-80, contains 0.6% by weight of silver ion-exchanged in Type A zeolite particles having an average particle size of about 1.0μ. Another formulation, AJ-80N, consists of about 2% by weight silver ion-exchanged in Type A zeolite particles having an average particle size of about 1.0μ. These zeolites preferably contain about between 0.5% and 2.5% by weight of ion-exchanged ammonium.

The zeolites are often obtained in master batches of low density polyethylene, polypropylene, or polystyrene, containing 20 wt. % of the zeolite. Thus, they can be easily mixed with the resins used as thermoplastic materials for forming the composite resin used to make or coat the plastic components of the grill.

A preferred embodiment of the resin has the following constituents:

plastic resin type

low density polyethylene

material of agent

silver zeolite (preferably type AJ10N)

wt. % of agent in composite

1.0%

size of the agent particles

1.0 micron

The antimicrobial particles are preferably present in a concentration by weight in the resin used to make the articles of from 0.01 to 10.0 wt%, more preferably from 0.01 to 8.0 wt %, and most preferably from 0.1 to 5.0 wt %. They are present on the surfaces of the grill to be contacted by the user or food.

The antimicrobial properties of the antimicrobial zeolite particles of the invention may be assayed while in aqueous formulations using conventional assay techniques, including for example determining the minimum growth inhibitory concentration (MIC) with respect to a variety of bacteria, eumycetes and yeast. In such a test, the bacteria listed below may be employed:

Escherichia coli;

Pseudomonas aeruginosa;

Staphylococcus aureus;

Aspergillus niger;

Salmonella typherium; and

Staphylococcus epidermis.

The assay for determining MIC can be carried out by smearing a solution containing bacteria for inoculation onto a plate culture medium to which a test sample of the encapsulated antimicrobial zeolite particles is added in a particular concentration, followed by incubation and culturing of the plate. The MIC is defined as a minimum concentration thereof required for inhibiting the growth of each bacteria.

Safety and biocompatibility tests were conducted on the antimicrobial zeolites employed in the invention. ISO 10993-1 procedures were employed. The following results were obtained:

| | |
|---|---|
| Cytotoxicity | Non-Toxic |
| Acute Systemic Toxicity | Non-Toxic |
| Oral Toxicity | Safer than table salt |
| Intracutaneous Toxicity | Passed |
| Skin Irritation Test | Non-Irritant |
| Chronic Toxicity | No Observable Effect |
| In-vitro Hemolysis | Non-Hemolytic |
| 30-day Muscle Implant Test | Passed |
| 60-day Muscle Implant Test | Passed |
| 90-day Muscle Implant Test | Passed |
| Ames Mutagenicity Test | Passed |
| Pyrogenicity | Non-Pyrogenic |

Thus, the antimicrobial zeolites are exceptionally suitable under relevant toxicity and biocompatibility standards for use in the grill components and are not adversely affected or deteriorated upon being contacted by foods and spilled beverages.

Specific features of the invention are shown in one or more of the drawings for convenience only, as each feature may be combined with other features in accordance with the invention. Alternative embodiments will be recognized by those skilled in the art and are intended to be included within the scope of the claims.

We claim:

1. A cooking grill comprising at least one part having a surface which is to be contacted by a body part of the grill user, food, food juices or a utensil, said at least one surface containing an inorganic antimicrobial agent.

2. A cooking grill as in claim 1 wherein the entirety of said at least one part is of a plastic resin containing said antimicrobial agent.

3. A cooking grill as in claim 2 wherein said grill includes at least one of a table, hood handle, control knob or button comprising said at least one part.

4. A cooking grill as in claim 1 wherein said surface is formed by a coating of a material containing said antimicrobial agent.

5. A cooking grill as in claim 4 wherein said grill includes at least one of a hood and body and a table comprising said at least one part.

6. A cooking grill as in claim 1 wherein said agent is an antimicrobial metal containing composition that imparts substantial antimicrobial action.

7. A cooking grill as in claim 6 wherein said inorganic antimicrobial metal comprises antimicrobial ceramic particles comprising said metal.

8. A cooking grill as in claim 7 wherein said ceramic particles are selected from the group consisting of zeolite, hydroxy apatite, and zirconium phosphate.

9. A cooking grill as in claim 6 wherein said inorganic antimicrobial metal containing composition comprises a silver salt.

10. A cooking grill as in claim 9 wherein said silver salt is selected from the group consisting of silver acetate, silver benzoate, silver carbonate, silver ionate, silver iodide, silver lactate, silver laureate, silver nitrate, silver oxide, silver palpitate, silver protein, and silver sulfadiazine.

11. A cooking grill as in claim 9 wherein said silver salt is silver nitrate.

12. A cooking grill as in claim 7 wherein said antimicrobial ceramic particles comprise antimicrobial zeolite prepared by replacing all or part of the ion-exchangeable ions in zeolite with an antimicrobial metal ion.

13. A cooking grill as in claim 12 wherein said antimicrobial metal is selected from the group consisting of silver, copper, zinc, and gold.

14. A cooking grill as in claim 6 wherein said antimicrobial metal is silver.

15. The cooking grill of claim 2 wherein said inorganic antimicrobial agent comprises from 0.25% to 10.0% by total weight of the resin and agent.

16. A cooking grill as in claim 1 wherein said antimicrobial agent is in particle form and the size of said particles is from 0.25 to 10.0 microns.

17. A cooking grill as in claim 4 wherein said coating is bonded to said tray and contains particles of said antimicrobial agent.

18. A cooking grill as in claim 17 wherein said agent is an antimicrobial metal containing composition that imparts substantial antimicrobial action.

19. A cooking grill as in claim 18 wherein said inorganic antimicrobial metal comprises antimicrobial ceramic particles comprising said metal.

20. A cooking grill as in claim 19 wherein said ceramic particles are selected from the group consisting of zeolite, hydroxy apatite, and zirconium phosphate.

21. A cooking grill as in claim 18 wherein said inorganic antimicrobial metal containing composition comprises a silver salt.

22. A cooking grill as in claim 17 wherein said antimicrobial agent is in particle form and the size of said particles is from 0.25 to 10.0 microns.

23. A cooking grill as in claim 4 wherein said coating is a paint in which the inorganic antimicrobial agent comprises 0.1 to 30% of the coating solids, preferably 0.5 to 15%, and most preferably 1 to 10%.
